(19) United States
(12) Patent Application Publication
(10) Pub. No.: US 2018/0078872 A1
(43) Pub. Date: Mar. 22, 2018

(54) ELECTRICAL ENERGY GENERATION SYSTEM COMBINING USE OF A DESALINATION FACILITY AND AN AQUIFER

(71) Applicant: William Riley, New Haven, CT (US)

(72) Inventor: William Riley, New Haven, CT (US)

(21) Appl. No.: 15/272,691

(22) Filed: Sep. 22, 2016

(51) Int. Cl. B01D 3/00; C02F 1/06; B01D 3/10; C02F 1/44; B01D 61/36; F01D 15/10; H02K 7/18

(52) U.S. Cl. CPC B01D 3/007; C02F 1/06; B01D 3/10; C02F 2103/08; B01D 61/364; F01D 15/10; H02K 7/1823; C02F 1/447

(57) ABSTRACT

In an example method, saline water is desalinated, and the desalinated water is directed to an aquifer. As the desalinated water is directed to the aquifer, kinetic energy associated with the desalinated water is converted into electrical energy.

### TECHNICAL FIELD

This disclosure relates to electrical energy generation systems combining use of desalination facilities and aquifers.

### BACKGROUND

Desalination is a process that removes minerals from saline water. As an example, desalination can remove salt and other minerals from ocean water, such that the water is more suitable for human consumption, agriculture, or other applications.

An aquifer is an underground layer of water-bearing permeable rock, rock fractures, and/or unconsolidated materials (e.g., gravel, sand, or silt) from which groundwater can be extracted. In some cases, water can be extracted from an aquifer using a water well that extends between the earth's surface and the aquifer.

### SUMMARY

The present disclosure describes, among other things, a method that includes desalinating saline water, directing the desalinated water to an aquifer, and converting kinetic energy associated with the desalinated water as the desalinated water is directed to the aquifer into electrical energy.

Some implementations of this aspect include, for example, one or more of the following features.

In some implementations, desalinating the saline water can include lowering a salt content of the saline water using a desalination facility.

In some implementations, the desalination facility can be powered, at least in part, using the electrical energy.

In some implementations, the desalination facility can be further powered using electrical energy obtained from at least one of a solar powered electric generator, a wind powered electric generator, a hydroelectric generator, and a steam generator.

In some implementations, directing the desalinated water to the aquifer can include directing the desalinated water through a conduit in fluid communication with the desalinating facility and the aquifer.

In some implementations, converting kinetic energy associated with the desalinated water as the desalinated water is directed to the aquifer into electrical energy can include directing the desalinated water through a turbine generator disposed in the conduit.

In some implementations, the method can further include disposing the desalination facility at a first elevation higher than a second elevation of the aquifer.

In some implementations, directing the desalinated water to the aquifer can include enabling the desalinated water to flow to the aquifer substantially under the influence of gravity.

In some implementations, the method can further include pumping desalinated water from the aquifer to a third elevation higher than the second elevation.

In some implementations, the method can further include obtaining the saline water from an ocean or bay in proximity to the desalination facility.

In some implementations, directing the desalinated water to the aquifer can include directing the desalinated water through a plurality of conduits in fluid communication with the desalinating facility and the aquifer. Converting kinetic energy associated with the desalinated water as the desalinated water is directed to the aquifer into electrical energy can include directing the desalinated water through a plurality of turbine generator disposed in the plurality of conduits.

According to another aspect, a system includes a desalination facility disposed at a first elevation. The desalination facility is configured to desalinate saline water. The system also includes an aquifer disposed at a second elevation lower than the first elevation, a conduit in fluid communication with the desalination facility and the aquifer, and a turbine generator disposed in the conduit. The turbine generator is configured to convert kinetic energy of desalinated water flowing through the conduit from the desalination facility to the aquifer into electrical energy.

Implementations of this aspect can include one or more of the following features.

In some implementations, the desalination facility can be powered, at least in part, by the electrical energy.

In some implementations, the system can further include an energy storage facility. The energy storage facility can be configured to store at least a portion of the converted electrical energy.

In some implementations, the system can further include an energy distribution facility. The energy distribution facility can be configured to relay at least a portion of the converted electrical energy to an entity remote from the system.

In some implementations, the system can further include an energy source having at least one of a solar powered electric generator, a wind powered electric generator, a hydroelectric generator, and a steam generator. The desalination facility can be powered, at least in part, using electrical energy obtained from the energy source.

In some implementations, the turbine generator can be further configured to pump desalinated water from the aquifer to a third elevation higher than the second elevation.

In some implementations, the conduit can include a pipe encasing a wellbore.

In some implementations, the turbine generator can be coupled to the pipe and can be configured such that desalinated water flowing through the pipe causes a rotor assembly of the turbine generator to rotate.

In some implementations, the system can further include one or more additional conduits in fluid communication with the desalination facility and the aquifer, and one or more additional turbine generators each of which is disposed in a respective one of the additional conduits. Each of the additional turbine generators can be configured to convert kinetic energy of desalinated water flowing through the respective conduit from the desalination facility to the aquifer into electrical energy.

One or more of the implementations described herein can provide various benefits. For example, implementations of an energy generation system can be operable to desalinate water and generate electrical power during the desalination process. The electrical power generated by the energy generation system can be used by the energy generation system itself (e.g., to power at least part of the desalination process) and/or relayed to other facilities for distribution and use. In some cases, an energy generation system can be substantially self-sustaining with respect to electrical power.

The details of one or more embodiments are set forth in the accompanying drawings and the description below. Other, aspects, features and advantages will be apparent from the detailed description and accompanying drawings, and from the claims.

### BRIEF DESCRIPTION OF DRAWINGS

FIGS. 1A and 1B are diagrams of an example energy generation system.

FIG. 2 is a diagram of an example arrangement of an energy generation system.

FIG. 3 is a diagram of another example energy generation system.

FIG. 4 is a diagram of another example energy generation system.

FIG. 5 is a diagram of another example energy generation system.

### DETAILED DESCRIPTION

Implementations of an energy generation system are described herein. Implementations of the energy generation system are operable to remove or otherwise reduce the presence of salt and other minerals from water. In some cases, water processed by the energy generation system is more suitable for use in a variety of applications (e.g., potable water for human consumption, irrigation water in support of agriculture, etc.).

In some cases, implementations of the energy generation system can be configured to replenish aquifers. As an example, a naturally occurring aquifer may provide potable water to a neighboring population. However, as the amount of groundwater contained within the aquifer is limited, extraction of groundwater depletes the aquifer over time. To replenish the aquifer, implementations of the energy generation system can desalinate water from a naturally occurring source of saline water (e.g., a neighboring ocean or salt water bay), and direct the desalinated water into the aquifer. This can be useful, for example, as it improves the sustainability of the aquifer and/or extends the usable life of the aquifer. Further, this enables desalinated water to be stored in a natural underground formation, thereby reducing or eliminating the need to construct man-made water storage structures (e.g., water tanks or reservoirs). Further, as desalinated water is stored underground instead of on the surface, the surface footprint of the energy generation system is reduced, thereby enabling the development and utilization of land for other purposes. Further still, desalinated water that is stored underground is less likely to be lost through evaporation, thereby improving the efficiency of the overall system.

In some implementations, the energy generation system can generate electrical energy by converting kinetic energy associated with the desalinated water into electrical energy. As an example, desalinated water can be directed to the aquifer through a conduit (e.g., a pipe, tube, or wellbore) extending between a desalination facility on or near the earth's surface and an underground aquifer. As the desalinated water flows downward under the influence of gravity, the water can be directed through one or more turbine generators positioned in the path of water flow. Kinetic energy from the flowing water can be converted into electrical energy (e.g., through the rotation of a turbine or rotor assembly by the flowing water), and the electrical energy can be relayed to the surface for distribution and/or use. In some cases, some or all of the electrical energy can be used to operate the energy generation system. In some cases, some or all of the electrical energy can be stored for future use and/or relayed to remote entities for use elsewhere.

In some cases, the energy generation system can be partially or entirely powered by the electricity energy generated on-site by the energy generation system. This can be useful, for example, as it enables the energy generation system to reduce and/or eliminate its consumption of electrical power from outside sources. In some implementations, energy generation system can be substantially self-sustaining with respect to electrical power. In some cases, the energy generation system can be partially or entirely powered by electrical energy obtained from alternative power sources, such as solar powered electric generators, wind powered electric generators, or hydroelectric generators. This can be useful, for example, as it enables the energy generation system to operate in a more environmentally conscious manner. In some cases, the energy generation system can be powered by a combination of the electrical energy generated on-site and electrical energy obtained from alternative power sources.

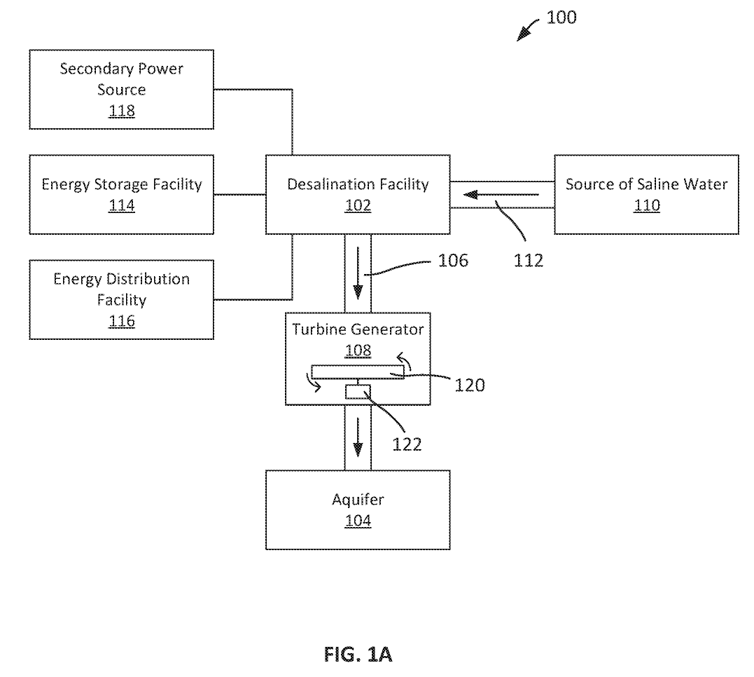

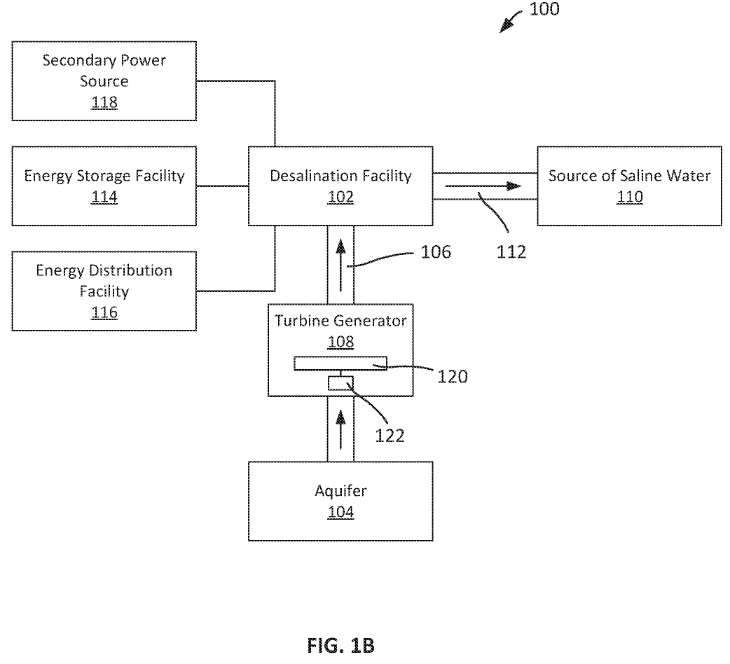

An example energy generation system 100 is shown schematically in FIG. 1A. The energy generation system 100 includes a desalination facility 102 and an aquifer 104. The desalination facility 102 and the aquifer 104 are in fluid communication with one another via a conduit 106 extending between them. The system 100 also includes a turbine generator 108 positioned in the fluid conduit 106.

As shown in FIG. 1A, during operation of the energy generation system 100, the desalination facility 102 draws saline water from a source of saline water 110 (e.g., via a conduit 112 extending between them). The desalination facility 102 desalinates the saline water (e.g., by removing or otherwise reducing a salt content and/or other mineral content of the saline water), and directing the desalinated water into the aquifer 104 through the conduit 106. As the desalinated water flows through the conduit 106, kinetic energy from the flowing desalinated water is converted into electrical energy by the turbine generator 108.

The converted electrical energy can be utilized in a various ways. In some cases, at least a portion of the converted electrical energy can be relayed to the desalination facility 102, and used to power the desalination facility 102. In some cases, at least a portion of the converted electrical energy can be relayed to an energy storage facility 114, and stored for later use (e.g., by the desalination facility 102 or other facilities near the desalination facility 102). In some cases, at least a portion of the converted electrical energy can be relayed to an energy distribution facility 116, which in turn relays the converted electrical energy to one or more remote locations. In this manner, energy generated by the energy generation system 100 can be used to power the energy generation system 100 itself, power one or more facilities nearby the energy generation system 100, and/or power one or more facilities remote from the energy generation system 100.

In some cases, the energy generation system 100 can be partially or entirely powered by the electrical energy generated by the turbine generator 108. This can be useful, for example, as it enables the energy generation system 100 to eliminate or reduce its consumption of electrical power from outside sources. In some cases, the energy generation system 100 can be partially or entirely powered by electrical energy generated by a secondary power source 118.

The desalination facility 102 includes one or more devices or systems to desalinate water. In some cases, the desalination facility 102 can remove salt and other minerals from saline water through vacuum distillation (e.g., a process by which saline water is boiled to separate impurities from the water) and/or membrane desalination (e.g., a process by which membranes and pressure are used to separate impurities from water).

The aquifer 104 is an underground layer of water-bearing permeable rock, rock fractures, and/or unconsolidated materials (e.g., gravel, sand, or silt) from which groundwater can be extracted. In some cases, the aquifer 104 can be a naturally occurring formation (e.g., a naturally occurring formation below the surface of the earth, with water naturally deposited in the formation).

In some cases, desalinated water from the desalination facility 102 can be used to replenish the aquifer 104. For example, if the water content of the aquifer 104 has been depleted (e.g., due to extraction of water over a period of time), desalinated water from the desalination facility 102 can be directed into the aquifer 104 and stored there, thereby increasing the water content of the aquifer 104 and/or slowing the rate of depletion of the aquifer 104. Water stored in this manner subsequently can be extracted for use, as if it were naturally deposited in the aquifer 104. Thus, the energy generation system 100 enables the replenishment of a naturally occurring aquifer, such that the usable life of the aquifer is extended.

The turbine generator 108 converts kinetic energy into electrical energy. As the desalinated water flows through the conduit 106, the turbine generator 108 converts at least a portion of the kinetic energy from the flowing desalinated water into electrical energy. In some cases, the turbine generator 108 can include one or more turbine or rotor assemblies 120 positioned in the path of the desalinated water flowing through the conduit 106. As the flowing water passes through the turbine generator 108, the flowing water rotates the turbine or rotor assemblies 120. This mechanical motion can be used to actuate one or more components 122 of a dynamo (e.g., a commutator) and/or an alternator (e.g., a magnet or an armature) to produce electrical current.

In some cases, the turbine generator 108 can include one or more pumps to pump water towards the aquifer 104 and/or away from the aquifer 104 (e.g., towards the desalination facility 102). As an example, in some cases, the turbine generator 108 can be a pump-turbine or a pump-as-turbine. This can be beneficial, for example, as a pre-existing installation may already have one or more pumps positioned in conduits extending between the surface of the earth and the aquifer 104. Thus, the turbine generator 108 can be implemented using some or all of those same pumps and conduits, thereby reducing the cost of implementing the energy generation system 100. Further, as described with respect to FIG. 1B, a pump-turbine or pump-as-turbine can extract water from the aquifer for use at the earth's surface.

As described herein, electrical energy generated by the turbine generator 108 can be utilized in various ways. In some cases, at least a portion of the generated electrical energy can be relayed to the desalination facility 102, and used to power the desalination facility 102. For example, the turbine generator 108 can be in electrical communication with the desalination facility 102 via an electrical conductor (e.g., one or more wires), such that electrical energy generated by the turbine generated 108 can be relayed directed to the desalination facility 102 for use.

In some cases, at least a portion of the converted electrical energy can be relayed to an energy storage facility 114, and stored for later use (e.g., by the desalination facility 102 or other facilities). The energy storage facility 114 can include, for example, one or more mechanical energy storage devices (e.g., compressed air energy storages devices, hydraulic accumulators, etc.), electrical energy storage devices (e.g., capacitors), biological energy storage devices (e.g., glycogen storage devices), electrochemical energy storage devices (e.g., batteries, supercapacitors, etc.), thermal energy storage devices (e.g., molten salt energy storage devices, steam accumulators, etc.), and/or chemical energy storage devices (e.g., hydrogen energy storage devices, power to gas energy storage devices, etc.) to store electrical energy.

In some cases, at least a portion of the converted electrical energy can be relayed to an energy distribution facility 116, which in turn relays the converted electrical energy to one or more remote locations. The energy distribution facility 116 can include, for example, one or more electrical transformers to convert electrical energy to a suitable current and voltage for transmission, and/or one or more electrical transmission lines to relay the electrical energy to a remote entity. In some cases, the energy distribution facility 116 can be interconnected with a general power grid (e.g., a municipal or regional power grid) to supply electrical energy to one or more consumers (e.g., households, businesses, etc.) across a particular area.

The secondary power source 118 provides electrical energy to the desalination facility 102 to support the operation of the desalination facility 102. In some cases, the secondary power source 118 can provide electrical energy generated using one or more alternative sources of energy. For example, the secondary power source 118 can include one or more solar powered electric generators, wind powered electric generators, hydroelectric generators, and/or steam generators. This can be useful, for example, as it enables the energy generation system 100 to operate in a more environmentally conscious manner. In some case, the secondary power source 118 can generate electrical energy using other sources of energy, such as gasoline, oil, coal, nuclear fission, and so forth. In some cases, electrical energy from the secondary power source 118 can be used to supplement the electrical energy generated by the generators 108 to support the operation of the desalination facility 102.

In some cases, the desalination facility 102 can draw saline water from a naturally occurring source of saline water 110. As an examples, the desalination facility 102 can draw saline water from a neighboring body of water such as an ocean or a bay. In some cases, the desalination facility 102 can draw saline water from an artificial source of saline water 110 (e.g., a man-made tank or reservoir).

The conduits 106 and 112 are apparatuses for conveying fluid from one location to another. In some cases, the conduits 106 and/or 112 can include one or more pipes, tubes, and/or channels for carrying fluid. As an example, the conduit 106 can include one or more pipes encasing one or more wellbores extending between the desolation facility 102 and the aquifer 104. As another example, the conduit 112 can include one or more pipes or tubes extending between the desalination facility 102 and the source of saline water 110.

In the example shown in FIG. 1A, the desalination facility 102 draws saline water from the source of saline water 110, and directs desalinated water to the aquifer 104. However, in some cases, the flow of fluid can be reversed across one or more portions of the energy generation system 100.

For example, as shown in FIG. 1B, the desalination facility 102 can draw water from the aquifer 104. This can be useful, for example, in extracting water from the aquifer 104 for use (e.g., for human consumption, agriculture, or other applications). In some cases, water can be drawn from the aquifer 104 through one or more pumps positioned in the conduit 106. In some cases, the turbine generator 108 can include one or more pumps (e.g., a pump-turbine generator, or a pump-as-turbine) to pump water towards the desalination facility 102 (e.g., for use as potable water for human consumption, irrigation water in support of agriculture, or other purposes).

As another example, as shown in FIG. 1B, the desalination facility 102 can expel water back into the source of saline water 110. This can be useful, for example, in expelling waste water from the desalination process (e.g., water containing salt and/or other minerals extracted from the desalinated water).

Although FIG. 1B shows water flowing across the same conduits 106 and 112 shown in FIG. 1A, this need not be the case. In some cases, the system 100 can include one or more additional conduits 106 and/or 112, and each conduit can be configured to transfer water in either direction selectively, or transfer water only in a single dedicated direction.

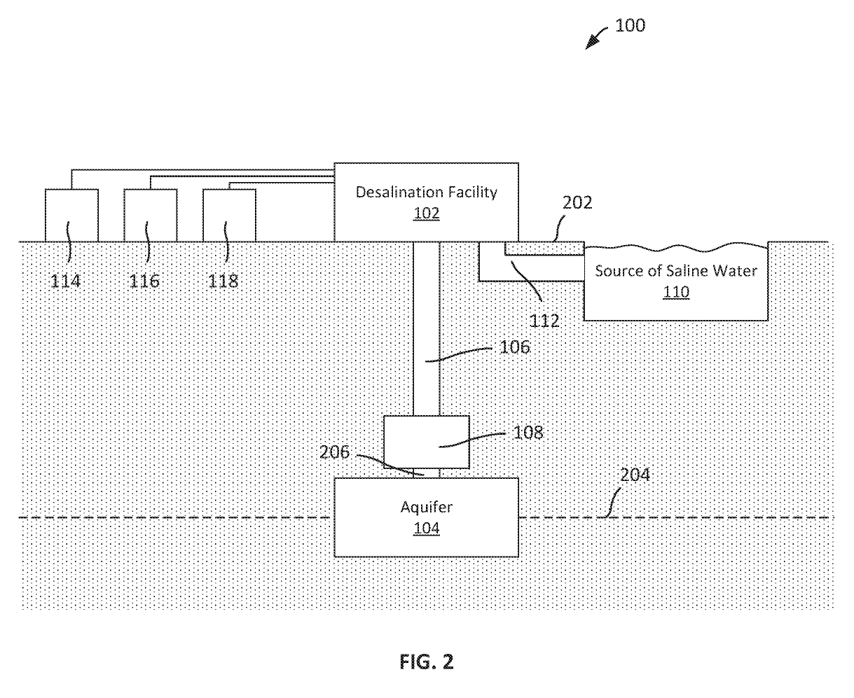

In some cases, the components of the energy generation system 100 can be disposed at particular elevations relative to one another to facilitate generation of electrical energy. For instance, FIG. 2 shows an example arrangement of the energy generation system 100. In this example, the desalination facility 102 is positioned on or near the earth's surface 202, and the aquifer 104 is positioned beneath the earth's surface 202 at a subterranean elevation 204. As the desalination facility 102 is at a higher elevation than the aquifer 104, desalinated water from the desalination facility 102 can flow to the aquifer 104 substantially under the influence of gravity. For example, once desalinated water has been directed to the conduit 106, the water can flow down the conduit 106 and through the turbine generator 108 under the influence of gravity and without the aid of pumps. This can be useful, for example, as it reduces the amount of energy required to transfer desalinated water from the desalination facility 102 to the aquifer 104. Further, as water flows through the turbine generator 108 without the aid of pumps, the turbine generator 108 can produce electrical energy more efficiently.

In some cases, the turbine generator 108 can be disposed on or near the bottom end 206 of the conduit 106. This can be useful, for example, as it enables the desalinated water to acquire a relatively large amount of kinetic energy (e.g., due to its descent down the conduit 106), thereby increasing the amount of electrical energy that can be generated by the turbine generator 108.

Further, water can be extracted from the aquifer 104 by pumping water from the aquifer 104 to a higher elevation (e.g., from the subterranean elevation 204 to the earth's surface 202). As described herein, this can be performed by the turbine generator 108 (e.g., a pump-turbine generator) and/or separate pumps positioned along the conduit 106 and/or one or more other conduits extending between the aquifer 104 and the earth's surface 202.

In the example shown in FIG. 2, the source of saline water 110 is positioned on the earth's surface 202 (e.g., a body of water exposed along the earth's surface, such as an ocean or bay), and water is extracted from the source of saline water 110 by an underground conduit 112. In some cases, however, the source of saline water 110 can be an underground body of water (e.g., an underground reservoir of saline water beneath the earth's surface). Further, in some cases, some or all of the conduit 112 can above the earth's surface 202 (e.g., a pipe or tube extending along the earth's surface).

Further, in the example shown in FIG. 2, the energy storage facility 114, and energy distribution facility 116, and the secondary power source 118 are each positioned on the earth's surface 202. However, in practice, one or more of these components can be positioned at different locations (e.g., beneath the earth surface 202).

Although configurations of the energy generation system 100 are shown in FIGS. 1A, 1B, and 2, these are merely illustrative examples. In practice, the energy generation system 100 can have different arrangements of components, depending on the implementation. Further, in practice, the energy generation system 100 can include more than one of some or all of the described components and/or exclude one or more of the described components.

For example, although a single conduit 106 and a single conduit 112 are shown in FIGS. 1A, 1B, and 2, in practice, there can be any number of conduits extending between each of the components of the system 100. Further, although the conduits 106 and 112 are shown as channels having a single entrance aperture and a single exit aperture (e.g., a single channeled tube or pipe), other configurations are also possible.

As another example, although a single turbine generator 108 is shown in FIGS. 1A, 1B, and 2, in practice, there may be any number of turbine generators 108 to generate electrical energy from flowing desalinated water.

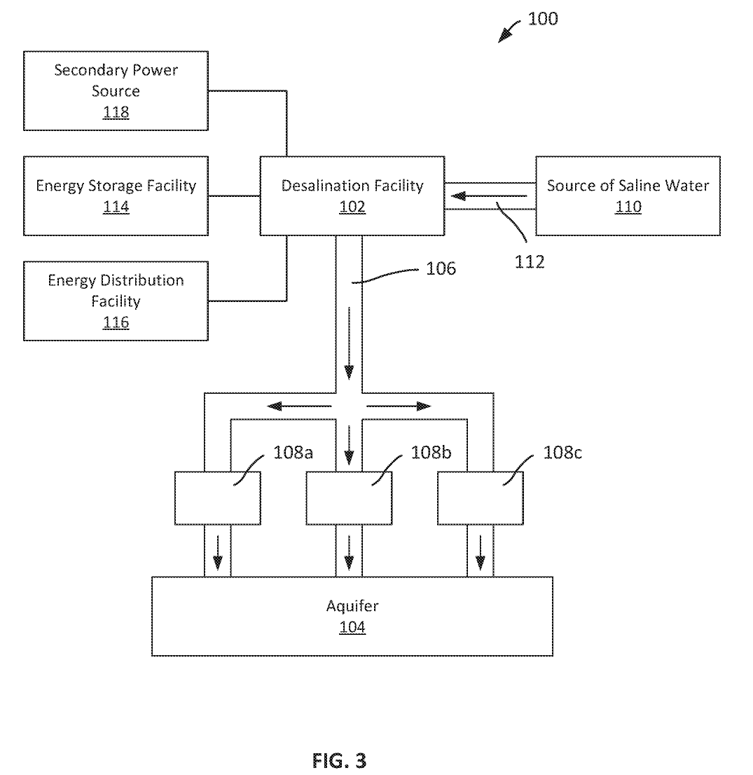

For instance, FIG. 3 shows another example energy generation system 100. In general, each of the components shown in FIG. 3 can operate similarly as those shown in FIG. 1. As an example, the desalination facility 102 can draw water from a source of saline water 110, and direct desalinated water into the aquifer 104, thereby replenishing the aquifer 104. Further, the system 100 can generate electricity from the flowing desalinated water, and either use the generated electrical energy to power the energy generation system 100 itself, power one or more facilities nearby the energy generation system 100, and/or power one or more facilities remote from the energy generation system 100.

However, in this example, the conduit 106 extends through multiple turbine generators 108a-c (e.g., through a branching, multi-channeled configuration). This enables the use of multiple turbine generators 108a-c simultaneously. This can be beneficial, for example, as it spreads the flow of desalinated water across multiple turbine generators 108a-c, such that the mechanical load across each of the turbine generators 108a-c is reduced. Further, this enables the energy generation system 100 to generate electricity more reliably (e.g., the energy generation system 100 can still generate electrical energy, even if some of the turbine generators 108a-c are damaged or disabled). In some cases, water can be selectively directed to particular turbine generators 108a-c (e.g., through the use to valves positioned along the conduit 106). This can be useful, for example, as it enables one or more of the turbine generators 108a-c to be serviced without interrupting the flow of desalinated water into the aquifer 104 and without interrupting the generation of electrical energy.

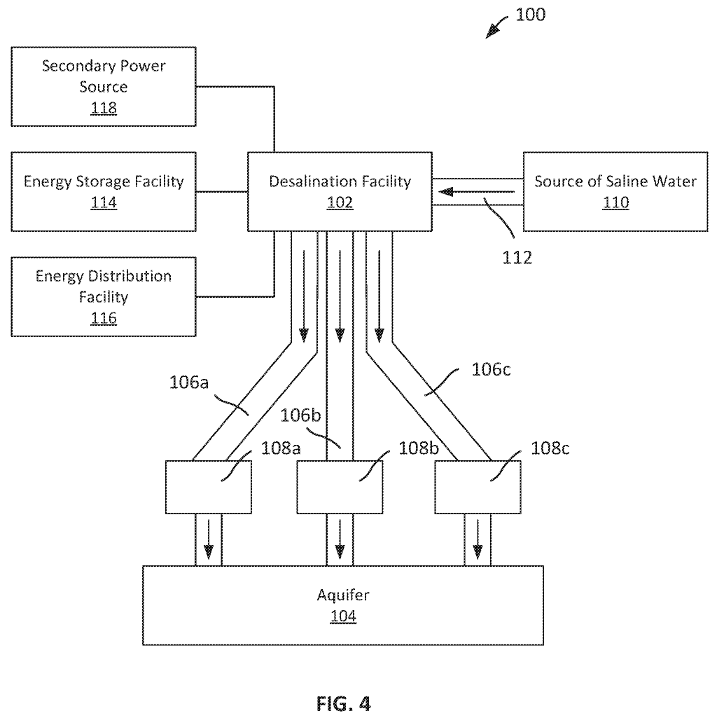

Another example energy generation system 100 is shown in FIG. 4. In general, each of the components shown in FIG. 4 can operate similarly as those shown in FIG. 1. As an example, the desalination facility 102 can draw water from a source of saline water 110, and direct desalinated water into the aquifer 104, thereby replenishing the aquifer 104. Further, the system 100 can generate electricity from the flowing desalinated water, and either use the generated electrical energy to power the energy generation system 100 itself, power one or more facilities nearby the energy generation system 100, and/or power one or more facilities remote from the energy generation system 100.

However, in this example, the energy generation system 100 includes multiple conduits 106a-c that extend through multiple turbine generators 108a-c. This enables the use of multiple turbine generators 108a-c simultaneously. As with the configuration shown in FIG. 3, this can be beneficial as it spreads the flow of desalinated water across multiple turbine generators 108a-c, such that the mechanical load across each of the turbine generators 108a-c is reduced. Further, this enables the energy generation system 100 to generate electricity more reliably (e.g., the energy generation system 100 can still generate electrical energy, even if some of the turbine generators 108a-c are damaged or disabled). In some cases, water can be selectively directed to particular turbine generators 108a-c (e.g., by selectively directing water into particular conduits 106a-c). This can be useful, for example, as it enables one or more of the turbine generators 108a-c to be serviced without interrupting the flow of desalinated water into the aquifer 104 and without interrupting the generation of electrical energy.

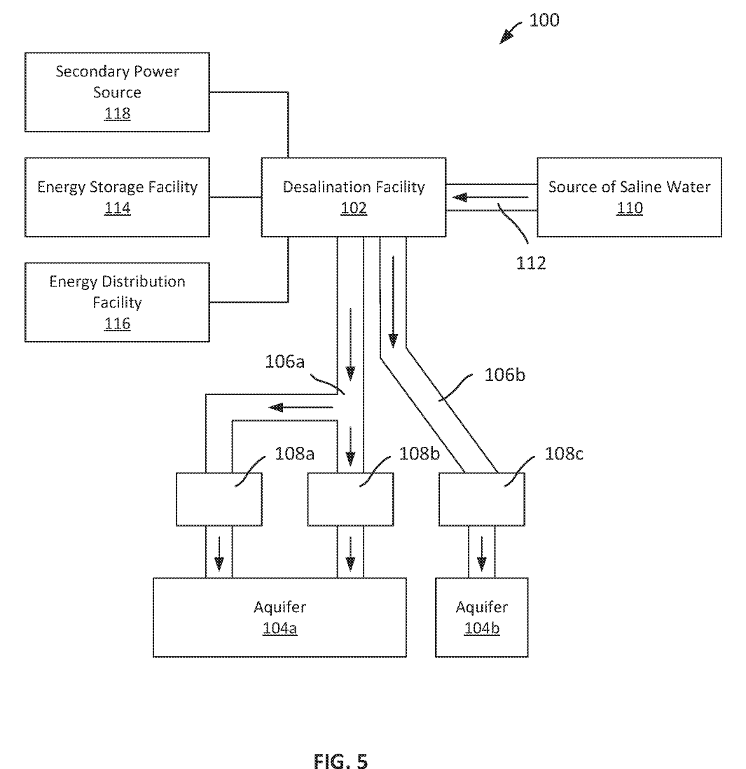

In some cases, the system 100 can be used to replenish multiple aquifers. For instance, FIG. 5 shows another example energy generation system 100. In general, each of the components shown in FIG. 5 can operate similarly as those shown in FIG. 1. As an example, the desalination facility 102 can draw water from a source of saline water 110, and direct desalinated water into an aquifer, thereby replenishing the aquifer. Further, the system 100 can generate electricity from the flowing desalinated water, and either use the generated electrical energy to power the energy generation system 100 itself, power one or more facilities nearby the energy generation system 100, and/or power one or more facilities remote from the energy generation system 100.

However, in this example, the energy generation system 100 can selectively replenish multiple aquifers 104a and 104b, either simultaneously or sequentially (e.g., one at a time). As shown in FIG. 6, the energy generation system 100 can include conduits 106a and 106b that each extend through one or more turbine generators 108a-c. This enables the use of multiple turbine generators 108a-c simultaneously. As with the configuration shown in FIG. 3, this can be beneficial as it spreads the flow of desalinated water across multiple turbine generators 108a-c, such that the mechanical load across each of the turbine generators 108a-c is reduced. Further, this enables the energy generation system 100 to generate electricity more reliably (e.g., the energy generation system 100 can still generate electrical energy, even if some of the turbine generators 108a-c are damaged or disabled).

In some cases, water can be selectively directed to particular turbine generators 108a-c (e.g., through the use to valves positioned along the conduit 106a and 106b and/or by selectively directing water into particular conduits 106a and 106b). This can be useful, for example, as it enables one or more of the turbine generators 108a-c to be serviced without interrupting the flow of desalinated water into aquifers 104a and/or 104b and without interrupting the generation of electrical energy.

Further, this enables the energy generation system 100 to replenish an aquifer and/or extract water stored in an aquifer independently for each aquifer. For example, the energy generation system 100 can replenish both aquifers 104a and 140b simultaneously (e.g., when both aquifers are depleted). As another example, the energy generation system 100 can replenish the aquifer 104a while extracting water from the aquifer 104b (e.g., when only the aquifer 104a is depleted). As another example, the energy generation system 100 can extract water from both aquifers 104a and 104b (e.g., when neither aquifer is depleted). In this manner, the energy generation system 100 can manage the water content of multiple aquifers simultaneously and in a flexible manner.

In practice, other configurations for the energy generation system 100 are also possible, depending on the implementation.

A number of implementations have been described. Nevertheless, it will be understood that various modifications may be made without departing from the spirit and scope of the invention. Accordingly, other implementations are within the scope of the claims.

What is claimed is:

1. A method comprising:
desalinating saline water;
directing the desalinated water to an aquifer; and
converting kinetic energy associated with the desalinated water as the desalinated water is directed to the aquifer into electrical energy.

2. The method of claim 1, wherein desalinating the saline water comprises:
lowering a salt content of the saline water using a desalination facility.

3. The method of claim 2, wherein the desalination facility is powered, at least in part, using the electrical energy.

4. The method of claim 3, wherein the desalination facility is further powered using electrical energy obtained from at least one of a solar powered electric generator, a wind powered electric generator, a hydroelectric generator, or a steam generator.

5. The method of claim 2, wherein directing the desalinated water to the aquifer comprises:
directing the desalinated water through a conduit in fluid communication with the desalinating facility and the aquifer.

6. The method of claim 5, wherein converting kinetic energy associated with the desalinated water as the desalinated water is directed to the aquifer into electrical energy comprises:
directing the desalinated water through a turbine generator disposed in the conduit.

7. The method of claim 2, further comprising:
disposing the desalination facility at a first elevation higher than a second elevation of the aquifer.

8. The method of claim 7, wherein directing the desalinated water to the aquifer comprises enabling the desalinated water to flow to the aquifer substantially under the influence of gravity.

9. The method of claim 7, further comprising:
pumping desalinated water from the aquifer to a third elevation higher than the second elevation.

10. The method of claim 2, further comprising:
obtaining the saline water from an ocean or bay in proximity to the desalination facility.

11. The method of claim 2, wherein directing the desalinated water to the aquifer comprises directing the desalinated water through a plurality of conduits in fluid communication with the desalinating facility and the aquifer, and
wherein converting kinetic energy associated with the desalinated water as the desalinated water is directed to the aquifer into electrical energy comprises directing the desalinated water through a plurality of turbine generator disposed in the plurality of conduits.

12. A system comprising:
a desalination facility disposed at a first elevation, wherein the desalination facility is configured to desalinate saline water;
an aquifer disposed at a second elevation lower than the first elevation;
a conduit in fluid communication with the desalination facility and the aquifer; and
a turbine generator disposed in the conduit, wherein the turbine generator is configured to convert kinetic energy of desalinated water flowing through the conduit from the desalination facility to the aquifer into electrical energy.

13. The system of claim 12, wherein the desalination facility is powered, at least in part, by the electrical energy.

14. The system of claim 12 further comprising an energy storage facility, wherein the energy storage facility is configured to store at least a portion of the converted electrical energy.

15. The system of claim 12 further comprising an energy distribution facility, wherein the energy distribution facility is configured to relay at least a portion of the converted electrical energy to an entity remote from the system.

16. The system of claim 12 further comprising an energy source having at least one of a solar powered electric generator, a wind powered electric generator, a hydroelectric generator, or a steam generator, and wherein the desalination facility is powered, at least in part, using electrical energy obtained from the energy source.

17. The system of claim 12, wherein the turbine generator is further configured to pump desalinated water from the aquifer to a third elevation higher than the second elevation.

18. The system of claim 12, wherein the conduit comprises a pipe encasing a wellbore.

19. The system of claim 12, wherein the turbine generator is coupled to the pipe and is configured such that desalinated water flowing through the pipe causes a rotor assembly of the turbine generator to rotate.

20. The system of claim 12 further comprising:
one or more additional conduits in fluid communication with the desalination facility and the aquifer, and
one or more additional turbine generators each of which is disposed in a respective one of the additional conduits, wherein each of the additional turbine generators is configured to convert kinetic energy of desalinated water flowing through the respective conduit from the desalination facility to the aquifer into electrical energy.
